(19) United States
(12) Patent Application Publication
(10) Pub. No.: US 2017/0154157 A1
(43) Pub. Date: Jun. 1, 2017

(54) DATA ANALYSIS DEVICE, CONTROL METHOD FOR DATA ANALYSIS DEVICE, AND CONTROL PROGRAM FOR DATA ANALYSIS DEVICE

(71) Applicant: FRONTEO, Inc., Tokyo (JP)

(72) Inventors: Masahiro MORIMOTO, Tokyo (JP); Naritomo IKEUE, Tokyo (JP); Hideki TAKEDA, Tokyo (JP)

(21) Appl. No.: 15/321,700

(22) PCT Filed: Jul. 8, 2014
(86) PCT No.: PCT/JP2014/068214

§ 371 Date: Dec. 22, 2016

(51) Int. Cl. G06F 19/00

(52) U.S. Cl. CPC G06F 19/345; G06F 19/324

(57) ABSTRACT

Object:

A user seeking predictive diagnosis for disease can be informed of diagnosis results with high credibility.

Resolution Means:

The present invention includes a relationship evaluating unit that, in cases where unjudged health care data is newly acquired for which it has not been judged whether or not a relationship with the predetermined symptom exists, evaluates a relationship between the unjudged health care data and the predetermined symptom on the basis of judged health care data for which a doctor has judged whether or not a relationship with the predetermined symptom exists; and a data informing unit that informs a user seeking a predictive diagnosis for disease of the unjudged health care data depending on a relationship evaluated by the relationship evaluating unit.

### TECHNICAL FIELD

The present disclosure relates to a data analysis device and the like capable of extracting health care data related to a predetermined symptom from a plurality of health care data acquired from structured health care data and/or unstructured health care data, and providing a predictive diagnosis for disease.

### BACKGROUND ART

In the medical field, a variety of medical information is generated including not only image data acquired by modalities such as CT, MRI, and PET; but also waveform data such as electrocardiograms and electroencephalograms; numerical data such as blood pressure and body temperature; and text data such as various examination reports and medical charts.

With the recent increases in awareness by individuals regarding heath, rather than seeking aid at a medical institution after becoming aware of a disease, there has been increased awareness for preventing disease or discovering and treating disease at an early stage.

With a wide variety of medical information, there is a growing level of awareness in individuals for prevention and early stage discovery/treatment of disease, and there is a need for means by which highly credible diagnosis results can be quickly obtained.

Patent Literatures 1 and 2 describe medical information display devices whereby medical information desired by a user can be easily acquired by a more intuitive operation, using an intuitive user interface such as a touch panel.

### CITATION LIST

### Patent Literature

Patent Literature 1: Japanese Unexamined Patent Application Publication No. 2012-048602A

Patent Literature 2: Japanese Unexamined Patent Application Publication (Translation of PCT Application) No. 2012-029265A1

### SUMMARY OF INVENTION

### Technical Problem

However, while the devices described in Patent Literatures 1 and 2 are for appropriately narrowing down to the desired medical information, they cannot perform a comprehensive analysis, predict diagnosis results, and inform a user seeking a predictive diagnosis for disease on the basis of that medical information.

In light of the problems described above, an object of the present invention is to provide a data analysis device and the like that extract health care data related to a predetermined symptom from a plurality of health care data acquired from structured health care data and/or unstructured health care data, and as a result of the extraction, can inform a user seeking a predictive diagnosis for disease of highly credible diagnosis results.

### Solution to Problem

In order to solve the problems described above, a data analysis device according to one aspect of the present invention is capable of extracting health care data related to a predetermined symptom from a plurality of health care data acquired from structured health care data and/or unstructured health care data, and providing a predictive diagnosis for disease. Such a device includes a relationship evaluating unit that, in cases where unjudged health care data is newly acquired for which it has not been judged whether or not a relationship with the predetermined symptom exists, evaluates a relationship between the unjudged health care data and the predetermined symptom on the basis of judged health care data for which a doctor has judged whether or not a relationship with the predetermined symptom exists; and a data informing unit that informs a user seeking a predictive diagnosis for disease of the unjudged health care data depending on a relationship evaluated by the relationship evaluating unit.

Additionally, the data analysis device according to one aspect of the present invention may further include a score calculating unit that calculates a score indicating a strength of a relationship between predetermined health care data and the predetermined symptom. According to this configuration, the relationship evaluating unit can use the score calculated by the score calculating unit as an index indicating a relationship between the unjudged health care data and the predetermined symptom to evaluate whether or not a relationship between the unjudged health care data and the predetermined symptom exists; and in cases where it is evaluated by the relationship evaluating unit that a relationship exists between the unjudged health care data and the predetermined symptom, the data informing unit can inform the user seeking a predictive diagnosis for disease of the unjudged health care data.

Additionally, the data analysis device according to one aspect of the present invention may further include a component evaluating unit that evaluates each data component included in the judged health care data, on the basis of a predetermined standard. According to this configuration, the score calculating unit can calculate the score using results evaluated by the component evaluating unit.

Additionally, the data analysis device according to one aspect of the present invention may further include a threshold identifying unit that, using the results evaluated by the component evaluating unit, and out of the scores calculated by the score calculating unit as an index indicating the relationship between the judged health care data and the predetermined symptom, identifies a score capable of exceeding a target value set for a precision ratio as a predetermined threshold.

Additionally, the data analysis device according to one aspect of the present invention may further include a condition determining unit that determines high and low correlations of moving averages of scores calculated for each of a plurality of judged health care data acquired along a time sequence with moving averages of scores calculated for each of a plurality of unjudged health care data acquired along a time sequence. According to this configuration, the relationship evaluating unit can evaluate the relationship between the unjudged health care data and the predetermined symptom, on the basis of results determined by the condition determining unit.

Additionally, the data analysis device according to one aspect of the present invention may further include a judged data acquiring unit that acquires the judged health care data by acquiring, from the doctor via a predetermined input unit, results judged by the doctor as to whether or not a relationship between a predetermined health care data and the predetermined symptom exists.

Additionally, the data analysis device according to one aspect of the present invention may further include a relationship imparting unit that imparts relationship information indicating that a relationship exists between the unjudged health care data and the predetermined symptom, on the basis of results evaluated by the relationship evaluating unit.

Additionally, the data analysis device according to one aspect of the present invention may further include a data acquiring unit that acquires, as the health care data, structured health care data including at least one of gene analysis data and health diagnosis data, and/or unstructured health care data including at least one of medical interview data, lifestyle data, patient clinical data, and family medical history.

Additionally, in the data analysis device according to one aspect of the present invention, the predetermined symptom may be a poor health condition.

In order to solve the problems described above, a control method for a data analysis device according to one aspect of the present invention is a control method for a data analysis device capable of extracting health care data related to a predetermined symptom from a plurality of health care data acquired from structured health care data and/or unstructured health care data, and providing a predictive diagnosis for disease. Such a method includes the steps of, in cases where unjudged health care data is newly acquired for which it has not been judged whether or not a relationship with the predetermined symptom exists, evaluating a relationship between the unjudged health care data and the predetermined symptom on the basis of judged health care data for which a doctor has judged whether or not a relationship with the predetermined symptom exists; and informing a user seeking a predictive diagnosis for disease of the unjudged health care data depending on a relationship evaluated in the relationship evaluating step.

In order to solve the problems described above, a control program for a data analysis device according to one aspect of the present invention is a control program for a data analysis device capable of extracting health care data related to a predetermined symptom from a plurality of health care data acquired from structured health care data and/or unstructured health care data, and providing a predictive diagnosis for disease. The program is configured to cause the data analysis device to execute a relationship evaluating function for, in cases where unjudged health care data is newly acquired for which it has not been judged whether or not a relationship with the predetermined symptom exists, evaluating a relationship between the unjudged health care data and the predetermined symptom on the basis of judged health care data for which a doctor has judged whether or not a relationship with the predetermined symptom exists; and a data informing function for informing a user seeking a predictive diagnosis for disease of the unjudged health care data depending on a relationship evaluated by the relationship evaluating function.

### Advantageous Effects of Invention

With the data analysis device, the control method for a data analysis device, and the control program for a data analysis device according to one aspect of the present invention, in cases where unjudged health care data is newly acquired for which it has not been judged whether or not a relationship with a predetermined symptom exists, the relationship between the unjudged health care data and the predetermined symptom is evaluated on the basis of judged health care data for which a doctor has judged whether or not a relationship with the predetermined symptom exists; and depending on the relationship, the unjudged health care data is comprehensively analyzed and a user seeking predictive diagnosis for disease is informed thereof.

Accordingly, the data analysis device and the like described above exhibit the advantageous effects of informing diagnosis results with high credibility.

### BRIEF DESCRIPTION OF DRAWINGS

FIG. 1 is a block diagram illustrating a main component configuration of a data analysis device according to an embodiment of the present invention.

FIG. 2 shows pattern diagrams illustrating an overview of the data analysis device described above.

FIG. 3 is a detailed flowchart illustrating an example of processing executed by the data analysis device described above.

### DESCRIPTION OF EMBODIMENTS

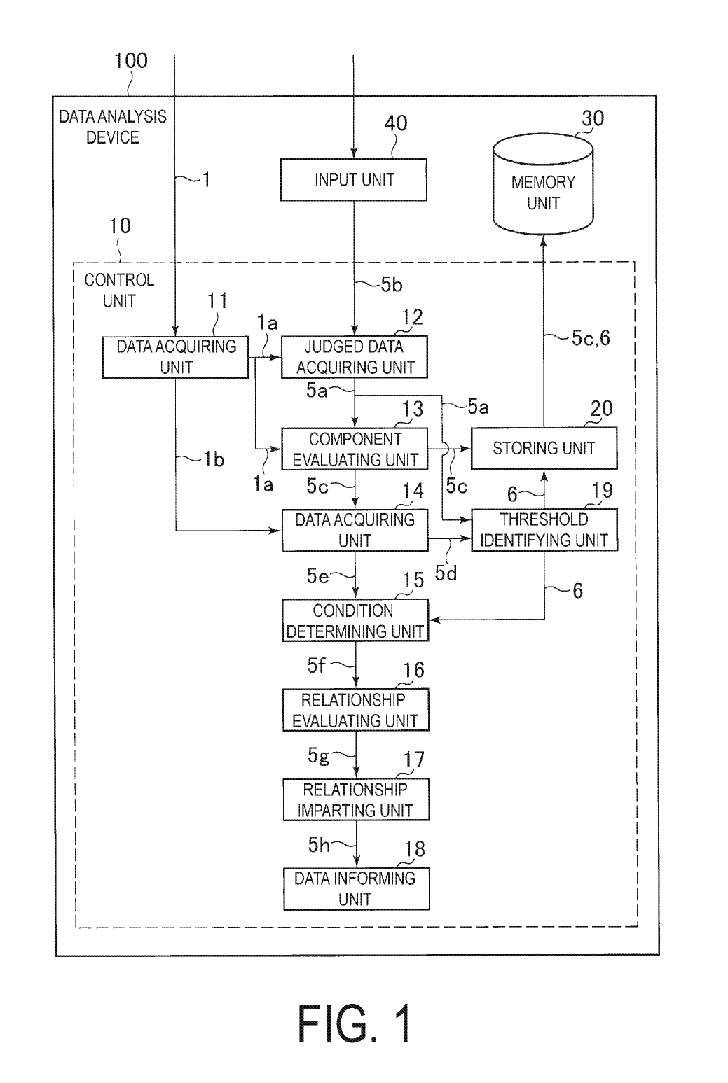

Embodiments of the present invention are described below while referencing FIGS. 1 to 3.

### Overview of Data Analysis Device 100

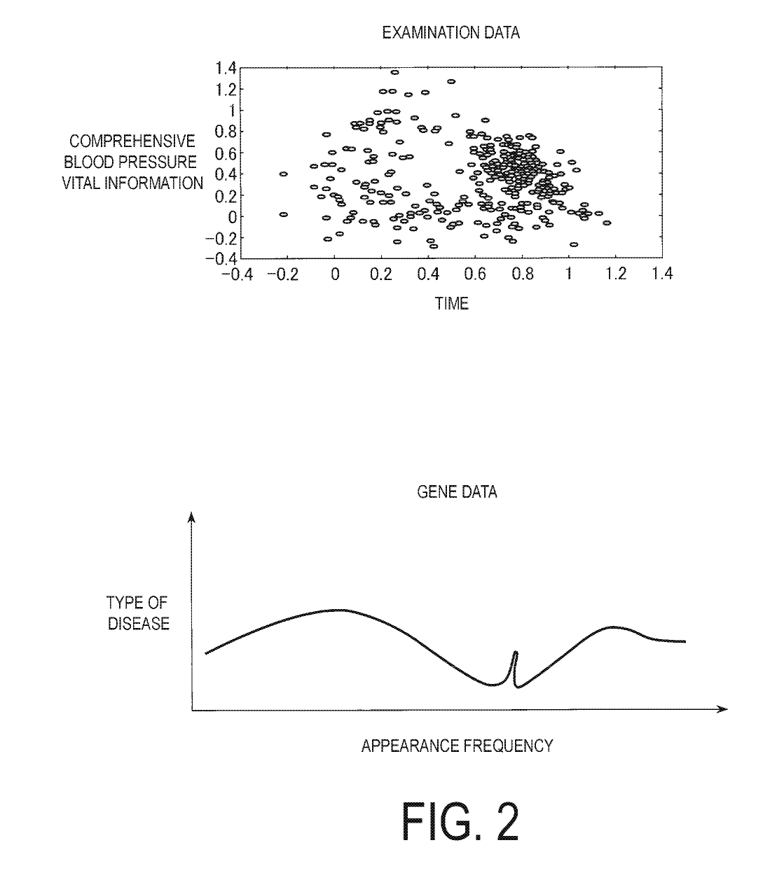

FIG. 2 are pattern diagrams illustrating an overview of a data analysis device 100. The data analysis device 100 is a device capable of extracting health care data related to a predetermined symptom from a plurality of health care data acquired from structured health care data and/or unstructured health care data. The data analysis device 100 described above may be a device on which the processing described below is executable and, for example, can be realized using a personal computer, a smart phone, other electronic devices, or the like.

As illustrated in FIG. 2, the data analysis device 100 acquires, for example, image information (data 1b) indicating circumstances very likely to lead to illness as unjudged health care data for which it has not been judged whether or not a relationship with a predetermined symptom exists. Here the phrase “predetermined symptom” described above widely includes symptoms, illnesses, diseases, syndromes, and the like determined by a doctor to be unhealthy conditions (conditions where physical or psychological problem or discomfort occurs in humans).

In cases where the unjudged health care data is newly acquired for which it has not been judged whether or not a relationship with the predetermined symptom exists, the data analysis device 100 evaluates the relationship between the unjudged health care data and the predetermined symptom on the basis of judged health care data for which a doctor (for example, an experienced doctor) has judged whether or not a relationship with the predetermined symptom exists. Specifically, the data analysis device 100 extracts data components 2 from the data 1b (for example, image data indicating circumstances very likely to lead to illness), and calculates a score Se of the data 1b from each of the data components 2 evaluated using the judged health care data. Then, in cases where the calculated score Se satisfies a predetermined condition (for example, when the score Se exceeds a predetermined threshold), the data analysis device 100 informs a user seeking predictive diagnosis for disease (for example, a patient or an inexperienced doctor) of the data 1b.

That is, the data analysis device 100 can determine whether or not to inform the user seeking predictive diagnosis for disease of the new unjudged health care data, on the basis of results judged by a doctor as to whether or not a relationship with the predetermined symptom exists. For example, in cases where an experienced doctor experiences a medical incident (an experience where the diagnosis of the doctor does not result in medical malpractice, but very well could have), the data analysis device 100 learns the relevance between the conditions of the medical incident (the predetermined symptoms) and external images depicting the conditions. Then, when similar external images are acquired by an inexperienced doctor as a result of encountering the same situation, the data analysis device 100 can inform the inexperienced doctor of these similar external images.

Accordingly, the data analysis device 100 exhibits the advantageous effect of informing diagnosis results with high credibility.

### Configuration of Data Analysis Device 100

FIG. 1 is a block diagram illustrating a main component configuration of the data analysis device 100. As illustrated in FIG. 1, the data analysis device 100 includes a control unit 10 (a data acquiring unit 11, a judged data acquiring unit 12, a component evaluating unit 13, a score calculating unit 14, a condition determining unit 15, a relationship evaluating unit 16, a relationship imparting unit 17, a data informing unit 18, a threshold identifying unit 19, and a storing unit 20), an input unit 40, and a memory unit 30.

The control unit 10 generally controls the various functions of the data analysis device 100. The control unit 10 includes the data acquiring unit 11, the judged data acquiring unit 12, the component evaluating unit 13, the score calculating unit 14, the condition determining unit 15, the relationship evaluating unit 16, the relationship imparting unit 17, the data informing unit 18, the threshold identifying unit 19, and the storing unit 20.

The data acquiring unit 11 acquires health care data 1 from structured health care data and/or unstructured health care data. The data acquiring unit 11 can, for example, acquire structured health care data including at least one and preferably two or more of gene analysis data and health diagnosis data (for example, height, weight, blood pressure, blood condition, and the like); and/or at least one and preferably two or more of examination data (for example, experiencing nausea and dizziness, symptoms first noticed 1-week ago, pain eases when sleeping facing left, burning sensation in affected area, and the like), lifestyle data (for example, smoker, drinks alcohol daily, exercises once per week, and the like), patient clinical data (for example, pregnant, suffering from diabetes, and the like), and family medical history (for example, father had cerebral infarction, mother had cancer, and the like) as the health care data 1.

Of the acquired health care data 1, the data acquiring unit 11 outputs data 1a, which is to be judged by a doctor as to whether or not a relationship with a predetermined symptom exists, to the judged data acquiring unit 12 and the component evaluating unit 13, and exports other data 1b (unjudged health care data) to the score calculating unit 14.

The judged data acquiring unit 12 acquires, from the doctor via the input unit 40, results (review results 5a) judged by the doctor as to whether or not a relationship between the data 1a and the predetermined symptom exists and, thereby, judged health care data (a pair of the data 1a and the review results 5a) is acquired. Specifically, the judged data acquiring unit 12 acquires the review results 5a that correspond to the data 1a that was input from the data acquiring unit 11, on the basis of input information 5b acquired from the input unit 40. Then, the judged data acquiring unit 12 outputs the review results 5a to the component evaluating unit 13 and the threshold identifying unit 19.

Note that the doctor that provides the review results 5a to the data analysis device 100 and the doctor that receives the review results from the data analysis device 100 (i.e. the doctor that is informed of the data 1b from the data analysis device 100) may be the same doctor or may be different doctors. In the case of the latter, for example, the data analysis device 100 can learn the experiences and determination standards of an experienced doctor and, on the basis of these learning results, inform an inexperienced doctor of the data 1b. In other words, the data analysis device 100 can use the experiences of an experienced doctor to the benefit of an inexperienced doctor.

The component evaluating unit 13 evaluates each data component included in the judged health care data on the basis of predetermined standards. Specifically, in cases where the data 1a is handwritten text information such as any type of examination report, medical chart, or the like, the component evaluating unit 13 converts the text information to document data. In cases where the data 1a is voice information recorded during an examination, the component evaluating unit 13 recognizes this voice information recorded during an examination and thereby, converts this voice information recorded during an examination to text (document data). Then, the component evaluating unit 13 uses the transmitted information volume, which indicates a dependency relationship between a keyword (a data component) included in the document data and the results (the review results 5a) of the judgement by the doctor on the data 1a (the voice information recorded during an examination or the text information such as any type of examination report, medical chart, or the like) that includes this keyword, as one of the predetermined standards described above, and calculates the weight of this keyword. Thus, the component evaluating unit 13 can evaluate this keyword. Note that the component evaluating unit 13 may recognize the voice information recorded during an examination described above using any type of voice recognition algorithm (for example, a hidden Markov model, a Kalman filter, a neural network, or the like).

Additionally, in cases where the data 1a is image information, the component evaluating unit 13 can identify objects included in the image information as data components by using any type of image-recognition technique (for example, pattern matching, Bayesian estimation, Markov chain Monte Carlo, or a similar technique). Then, the component evaluating unit 13 uses the transmitted information volume, which indicates a dependency relationship between an object (a data component) included in the image information and the results (the review results 5a) of the judgement by the doctor on the data 1a (the image information) that includes this object, as one of the predetermined standards described above, and calculates the weight of this object. Thus, the component evaluating unit 13 can evaluate this object. The component evaluating unit 13 outputs component information 5c, which is a pair consisting of the data component described above and the weight of this data component, to the score calculating unit 14 and the storing unit 20.

The score calculating unit 14 calculates a score 5d indicating the strength of the relationship between the data 1a and the predetermined symptom using the results (the component information 5c) evaluated by the component evaluating unit H. The score calculating unit 14 outputs the calculated score 5d to the threshold identifying unit 19. Additionally, in cases where the data 1b (the unjudged health care data) is input from the data acquiring unit 11, the score calculating unit 14 calculates a score 5e for the data 1b and outputs this calculated score 5e to the condition determining unit 15.

The score calculating unit 14 can calculate the score (the score 5d or the score 5e) of the health care data 1 by summing the weights of the data components included in the health care data 1 (the data 1a or the data 1b). For example, a situation is envisioned of the health care data 1 being dialog voice information recorded during an examination in an examination room where a patient is asked, “Describe your symptoms” and replies, “I started feeling nauseous about one week ago.” Here, in a case where weights of 1.2 and 2.2 are assigned to the data components “one week ago” and “nauseous”, respectively, as a result of evaluation of the data components by the component evaluating unit 13, the score calculating unit 14 can calculate the score of this data 1 as 3.4 (1.2+2.2).

Specifically, the score calculating unit 14 generates a component vector indicating whether or not a predetermined data component is included in the health care data 1. This component vector indicates whether or not predetermined data components associated with the components are included in the health care data 1, by each of the components of the component vector taking a value of 0 or 1. For example, in a case where the health care data 1 described above includes the data component “one week ago”, the score calculating unit 14 changes the component of the component vector associated with “one week ago” from 0 to 1. Then, the score calculating unit 14 calculates a score S of the data 1 by calculating the inner product of the component vector (vertical vector) described above and a weight vector (vertical vector with the weight for each data component as a component) according to the following formula.

S=w^{T}·s Formula 1

Here, s represents the component vector and W represents the weight vector. Note that T represents a transpose of the matrix-vector (switching the rows and columns)

Additionally, the score calculating unit 14 may calculate the score S using the following formula.

$$S = \frac{{\sum }_{j = 0}^{N} {jm}_{j} {w}_{j}^{2}}{{\sum }_{i = 0}^{N} {iw}_{i}^{2}} \qquad Formula 2$$

Here, mⱼ represents an appearance frequency of a j-th data component, and wᵢ represents the weight of an i-th data component.

Note that the score calculating unit 14 may calculate the score 5d and/or the score 5e on the basis of the results (the weight of a first data component) evaluated for a first data component included in the data 1a and/or the data 1b, and the results (the weight of a second data component) evaluated for a second data component included in the data 1a and/or the data 1b. That is, in cases where the first data component appears in the data, the score calculating unit 14 can calculate the score of the data while taking into consideration the frequency at which the second data component appears in the data (that is, the correlation between the first data component and the second data component, or “co-occurrence”). As such, the score can be calculated while taking into consideration the correlation between the data components and, as a result, the data analysis device 100 can extract data related to the predetermined symptom with greater accuracy.

The condition determining unit 15 determines whether or not the data 1b satisfies predetermined conditions for informing the user seeking predictive diagnosis for disease of the data 1b, on the basis of the score Se calculated by the score calculating unit 14. For example, the condition determining unit 15 may determine whether or not the score Se exceeds a relevance threshold (the predetermined threshold) 6 as one of the predetermined conditions described above. In this case, the determination is made by comparing the score 5e with a relevance threshold 6.

Additionally, the condition determining unit 15 may determine whether or not correlation has increased between a moving average of the scores 5d and a moving average of the scores 5e as one of the predetermined conditions described above. In this case, the moving average is an average of the scores 5d and is calculated for each of a plurality of the data 1a acquired along a time sequence, and the moving average is an average of the scores Se and is calculated for each of a plurality of the data 1b acquired along a time sequence. For example, in cases where the review results 5a are data obtained from an experienced doctor, where the review results 5a shows that the plurality of data 1a described above indicate a situation where a medical incident was experienced (an experience where the diagnosis of a doctor does not result in medical malpractice, but very well could have), the condition determining unit 15 extracts the moving average of the scores 5d calculated for each of the plurality of data 1a as a predetermined pattern.

Then, the condition determining unit 15 calculates the correlation between the predetermined pattern described above and the moving average of the scores Se described above. In other words, the condition determining unit 15 calculates a degree of matching (correlation) between the moving averages while shifting the elapsed time and/or the scores. In cases where the correlation is high, the condition determining unit 15 determines that the current score Se will take a similar value in the future so as to coincide with the predetermined pattern described above (that is, there is a high possibility that the same incident will occur).

Additionally, the condition determining unit 15 may determine whether or not correlation has increased between a change in biological information (the data 1a) of a third party that was acquired in the past by the data acquiring unit 11 and a change in biological information (the data 1b) of the user seeking predictive diagnosis for disease (for example, a patient) as one of the predetermined conditions described above. For example, in cases where the review results 5a are data obtained from an experienced doctor, where the review results 5a show that the biological information described above (the data 1a) indicate a situation where an incident was experienced, the condition determining unit 15 calculates the correlation for the changes of both biological information. In cases where this correlation has increased, the condition determining unit 15 determines that the current biological information will take a similar value in the future so as to coincide with the past biological information (that is, there is a high possibility that the same incident will occur) The condition determining unit 15 outputs the results of the determination (determination results 5f) to the relationship evaluating unit 16.

In cases where unjudged health care data (the data 1b) for which it has not been judged whether or not a relationship with the predetermined symptom exists is newly acquired, the relationship evaluating unit 16 evaluates the relationship between the unjudged health care data and the predetermined symptom on the basis of the judged health care data (pairs consisting of the data 1a and the review results 5a) for which a doctor has judged whether or not a relationship with the predetermined symptom exists. For example, as an index indicating the relationship between the unjudged health care data (the data 1b) and the predetermined symptom, in cases where the score 5e calculated by the score calculating unit 14 exceeds the threshold 6 (that is, in cases where it is determined by the condition determining unit 15 that the threshold 6 is exceeded), the unjudged health care data and the predetermined symptom are evaluated to be related. The relationship evaluating unit 16 outputs the results of the evaluation (evaluation results 5g) to the relationship imparting unit 17.

The relationship imparting unit 17 imparts relationship information 5h that indicates that the unjudged health care data (the data 1b) is related to the predetermined symptom, on the basis of the results of the evaluation (the evaluation results 5g) by the relationship evaluating unit 16 and outputs the relationship information 5h to the data informing unit 18.

The data informing unit 18 informs the user seeking predictive diagnosis for disease of the unjudged health care data (the data 1b) depending on the relationship evaluated by the relationship evaluating unit 16. Specifically, the data informing unit 18 informs the user seeking predictive diagnosis for disease described above of the data 1b to which the relationship information 5h indicating a relationship with the predetermined symptom has been imparted by the relationship imparting unit 17.

The threshold identifying unit 19 identifies, as the relevance threshold 6, the lowest score capable of exceeding a target value (target precision ratio) set for the precision ratio that indicates the proportion of the data 1a judged to be related to the predetermined symptom in a data group including a predetermined number of data. Specifically, in cases where the scores 5d are input from the score calculating unit 14, the threshold identifying unit 19 sorts the scores 5d in descending order. Next, starting from the data 1a that has the highest score 5d (score rank is No. 1), the threshold identifying unit 19 scans, in order, the review results 5a imparted to the data 1a and sequentially calculates a proportion (precision ratio) of the number of data, to which review results 5a have been imparted that indicate “related to the predetermined symptom”, in the number of data for which the scanning is currently completed.

For example, in a case where the number of the data 1a to which review results 5a have been imparted is 100, at a point where the scanning of the data of score rankings No. 1 to No. 20 is completed, in a case where the number of data to which review results 5a have been imparted that indicate “related to the predetermined symptom” is 18, the threshold identifying unit 19 calculates a precision ratio of 0.9 (18/20). Alternatively, at a point where the scanning of the data of score rankings No. 1 to No. 40 is completed, in a case where the number of data to which review results 5a have been imparted that indicate “related to the predetermined symptom” is 35, the threshold identifying unit 19 calculates a precision ratio of 0.875 (35/40).

The threshold identifying unit 19 calculates all of the precision ratios for the data 1a and identifies the lowest score capable of exceeding the target precision ratio. Specifically, starting from the data 1a that has the lowest score 5d (score rank is No. 100), the threshold identifying unit 19 scans, in order, the precision ratios calculated for the data 1a. In cases where the precision ratio exceeds the target precision ratio, the threshold identifying unit 19 outputs the score corresponding to that precision ratio to the condition determining unit 15 and the storing unit 20 as the lowest score (the relevance threshold 6) capable of maintaining the target precision ratio described above.

In cases where the component information 5c is input from the component evaluating unit 13, the storing unit 20 associates the data components included in the component information 5c with the results (weight) of the evaluation of the data components, and stores these in the memory unit 30. As a result, the data analysis device 100 can extract data related to a predetermined symptom by analyzing current data on the basis of the results of analyses of past data (the weight as the result of the evaluation of the data components). Additionally, in cases where the relevance threshold 6 is input from the threshold identifying unit 19, the storing unit 20 stores this relevance threshold 6 in the memory unit 30.

The input unit (predetermined input unit) 40 receives input from a doctor. FIG. 1 illustrates a configuration in which the data analysis device 100 is provided with the input unit 40 (for example, a configuration in which a keyboard, mouse, or the like is connected as the input unit 40), but the input unit 40 may be an external input device connected such that communication is possible with the data analysis device 100 (for example, a client terminal).

The memory unit (predetermined memory unit) 30 is a memory device constituted by any type of recording media such as, a hard disk, a solid state drive (SSD), semiconductor memory, a DVD, or the like. Control programs capable of controlling the component information 5c, the relevance threshold 6, and/or the data analysis device 100 are stored in the memory unit 30. Note that FIG. 1 illustrates a configuration in which the memory unit 30 is built into the data analysis device 100, but the memory unit 30 may be an external memory device connected such that communication is possible with the data analysis device 100.

### Recalculation of Weighting

After the user seeking predictive diagnosis for disease has been informed by the data informing unit 18 of the data 1b that has been determined by the data analysis device 100 to be related to the predetermined symptom, the judged data acquiring unit 12 can receive feedback from a doctor regarding the determination. That is, a doctor can input, as the feedback described above, whether or not each of the results of the determinations by the data analysis device 100 is appropriate.

The component evaluating unit 13 can re-evaluate each of the data components on the basis of the feedback described above. Specifically, the component evaluating unit 13 calculates the weight of each data component using the following formula:

$${w}_{i , L} = \sqrt{{w}_{i , L}^{2} + {γ}_{L} {w}_{i , L}^{2} - ϑ} = \sqrt{{w}_{i , L}^{2} + {\sum }_{l = 1}^{L} ( {γ}_{l} {w}_{i , l}^{2} - ϑ )} \qquad Formula 3$$

Here, w_{i,L} represents the weight of an i-th data component after an L-th learning, γ_{L} represents a learning parameter at the L-th learning, and θ represents a threshold for learning results.

That is, the component evaluating unit 13 recalculates the weights on the basis of newly obtained feedback on the determinations of the data analysis device 100. As such, the data analysis device 100 can acquire weight that has been adapted to data that is the subject of analysis and an accurate score can be calculated on the basis of this weight. As a result, the data analysis device 100 can extract data related to the predetermined symptom with greater accuracy.

### Processing Executed by the Data Analysis Device 100

The processing executed by the data analysis device 100 (a control method for the data analysis device 100) includes, in cases where unjudged health care data (the data 1b) is newly acquired for which it has not been judged whether or not a relationship with the predetermined symptom exists, evaluating a relationship between the unjudged health care data and the predetermined symptom on the basis of judged health care data (pairs consisting of the data 1a and the review results 5a) for which a doctor has judged whether or not a relationship with the predetermined symptom exists (a relationship evaluating step); and informing a user seeking a predictive diagnosis for disease of the unjudged health care data depending on the relationship evaluated in the relationship evaluating step (a data informing step).

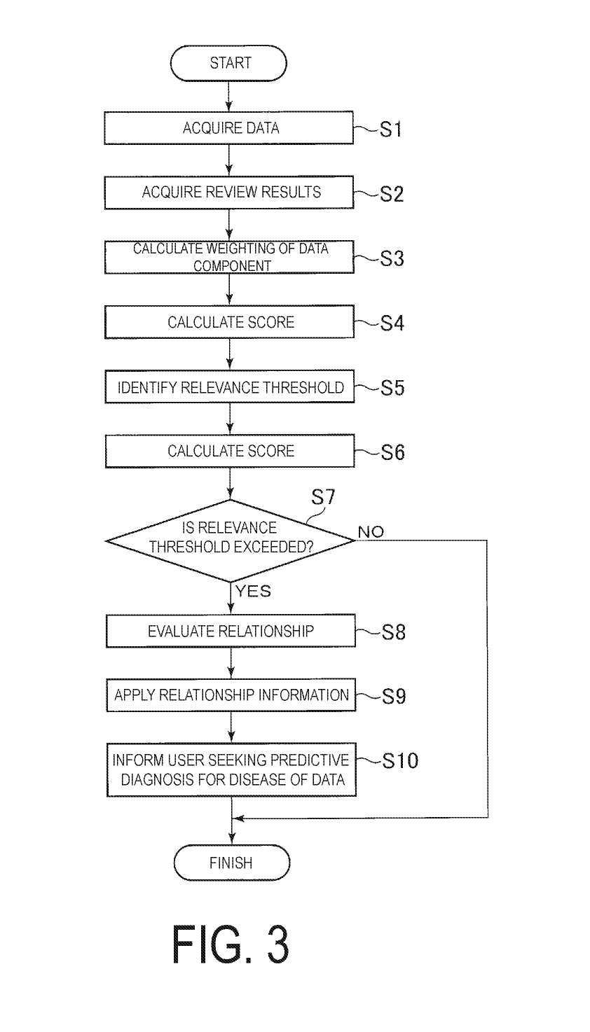

FIG. 3 is a detailed flowchart illustrating an example of the processing executed by the data analysis device 100. Note that in the following description, the parenthetical recitations of the “ . . . step” represent the steps included in the control method for the data analysis device described above.

The data acquiring unit 11 acquires data 1a (from, for example, a camera that takes external images, a microphone that records voices during an examination, or the like), which is to be judged by a doctor as to whether or not a relationship with a predetermined symptom exists (step 1, hereinafter “step” is recited as “S”). Next, the judged data acquiring unit 12 acquires the results (the review results 5a) of the judgement by the doctor as to whether or not a relationship exists between the data 1a and the predetermined symptom via the input unit 40 (S2). Next, the component evaluating unit 13 evaluates each data component included in the data that has been judged by a doctor as to whether or not a relationship with the predetermined symptom described above exists, on the basis of predetermined standards (S3). Then, the score calculating unit 14 calculates a score 5d indicating the strength of the relationship between the data 1a and the predetermined symptom described above on the basis of the results (the component information 5c) evaluated by the component evaluating unit 13 (S4); and the threshold identifying unit 19 identifies, as the relevance threshold 6, the lowest score capable of exceeding a target value (target precision ratio) set for the precision ratio that indicates the proportion of the data 1a judged to be related to the predetermined symptom in a data group including a predetermined number of data (S5).

Next, the score calculating unit 14 calculates a score 5e indicating the strength of the relationship with the predetermined symptom described above for each of the data 1b on the basis of the results (the component information 5c) evaluated by the component evaluating unit 13 (S6). The condition determining unit 15 determines whether or not the score 5e calculated for the data 1b, for which determination as to whether or not a relationship with the predetermined symptom described above exists has not been performed, exceeds the relevance threshold 6, on the basis of the results (the component information 5c) evaluated by the component evaluating unit 13 (S7); and in cases where it is determined to be exceeding the relevance threshold 6 (S7; YES), the relationship evaluating unit 16 evaluates the data 1b to be related to the predetermined symptom described above (S8; the relationship evaluating step).

The relationship imparting unit 17 imparts relationship information (review results by the document analysis system 100) indicating that the data 1b is related to the predetermined symptom described above, where the data 1b has been evaluated by the relationship evaluating unit 16 (S9). Lastly, the data informing unit 18 informs the user seeking predictive diagnosis for disease of the data 1b (S10, the data informing step).

Note that the control method described above may, in addition to the processing described while referencing FIG. 2, optionally include processing to be executed at each unit included in the control unit 10.

### Advantageous Effects Provided by the Data Analysis Device 100

As described above, with the data analysis device 100, in cases where unjudged health care data is newly acquired for which it has not been judged whether or not a relationship with a predetermined symptom exists, the relationship between the unjudged health care data and the predetermined symptom is evaluated on the basis of judged health care data for which a doctor has judged whether or not a relationship with the predetermined symptom exists; and depending on the relationship, a user seeking predictive diagnosis for disease is informed of the unjudged health care data.

Accordingly, the data analysis device 100 exhibits the advantageous effect of informing diagnosis results with high credibility.

Configuration in which a Server Device Provides a Part or all of the Functions

In the description given above, a configuration (stand-alone configuration) was described in which the control program of the data analysis device capable of extracting health care data related to a predetermined symptom from a plurality of health care data acquired from structured health care data and/or unstructured health care data is executed on the data analysis device 100.

However, a configuration (cloud configuration) is possible in which a part or all of the control program described above is executed on a server device, and the results of the executed processing are returned to the data analysis device 100 (user terminal). That is, the data analysis device of the present invention can function as a server device which is connected to a user terminal such that communication via a network is possible. As a result of this configuration, the server device provides the same advantageous effects as are provided by the data analysis device 100 described above when the functions are provided by the data analysis device 100.

### Software Implementation Example

The control block (particularly the control unit 10) of the data analysis device 100 may be implemented by a logic circuit formed on an integrated circuit (IC chip) or the like (hardware), or may be implemented by software using a central processing unit (CPU). In the case of the latter, the data analysis device 100 includes a CPU for executing commands of the control program of the data analysis device 100 (i.e. the software for executing the functions), read only memory (ROM) or a memory device (referred to as “recording media”) in which the control program and various data are recorded so as to be readable by a computer (or the CPU), random access memory (RAM) for deploying the control program described above, and the like. An object of the present invention may be achieved by the computer (or the CPU) reading the control program described above from the recording media and executing the control program. Examples of the recording media described above include “non-temporary tangible media” such as, tapes, discs, cards, semiconductor memory, and programmable logic circuits. Additionally, the control program described above may be supplied to the computer via any transmission media (communication networks, broadcast waves, and the like) capable of transmitting the control program. The present invention may be implemented in the form of a data signal embedded in a carrier wave, in which the control program described above is realized by electronic transmission.

Specifically, the control program for the data analysis device according to an embodiment of the present invention is a control program for a data analysis device capable of extracting health care data related to a predetermined symptom from a plurality of health care data acquired from structured health care data and/or unstructured health care data, and causes the relationship evaluating function and the data informing function to be implemented on the data analysis device described above. The relationship evaluating function and the data informing function described above are implementable by the relationship evaluating unit 16 and the data informing unit 18 described above, respectively. Details thereof are as described above.

Note that the control program described above can, for example, be implemented using a script language such as Python, ActionScript, or JavaScript®; an object-oriented programming language such as Objective-C, Java®; a markup language such as HTML5; or the like.

### Additional Matter 1

The present invention is not limited to the embodiments described above and various modifications within the scope of the claims are possible. It should be understood that embodiments obtained by appropriately combining the technical means described in different embodiments are included within the technical scope of the present invention. Furthermore, novel technical features may be formed by combining the technical means described in each of the embodiments.

Additionally, in the data analysis device according to one aspect of the present invention, the component evaluating unit can use the transmitted information volume, which indicates a dependency relationship between a data component and the results of the judgement by the doctor on the judged data that includes this data component, as one predetermined standard, and can evaluate this data component.

### Additional Matter 2

A data analysis device according to one aspect of the present invention acquires digital information including data, patient information, and access history information, specifies a specific patient from the patient information, and, on the basis of the access history information related to the stipulated specific patient, extracts only data that the specific patient has accessed. Furthermore, the data analysis device sets supplementary information indicating whether or not a predetermined file included in the extracted data is relevant to a predetermined symptom and, on the basis of the supplementary information, outputs the predetermined file that is relevant to the predetermined symptom.

A data analysis device according to one aspect of the present invention acquires digital information including data and patient information, and sets patient identifying information indicating which patient, among the patients included in the patient information, the digital information is relevant to. Furthermore, the data analysis device specifies a patient, searches for a predetermined file for which the patient identifying information corresponding to the specified patient is set, sets supplementary information indicating whether or not the predetermined file that has been found is relevant to a predetermined symptom and, on the basis of the supplementary information, outputs the predetermined file that is relevant to the predetermined symptom.

With a data analysis device according to one aspect of the present invention, (1a) a classifying mark A, (1b) a data component included in data marked with the classifying mark A, and (1c) data component corresponding information indicating a correspondence relationship between the classifying mark A and the data component are saved in a data component database. Furthermore, (2a) a classifying mark B, (2b) a relevant data component with a high frequency of appearance in the data marked with the classifying mark B, and (2c) relevant data component corresponding information indicating a correspondence relationship between the classifying mark B and the relevant data component are saved in a relevant data component database. Data including the data component (1b) described above is marked with the classifying mark A, on the basis of the data component corresponding information (1c) described above. Data including the relevant data component (2b) described above is extracted from the data that was not marked with the classifying mark A, and a score is calculated on the basis of an evaluation value/number of the relevant data component. Moreover, data with a score that exceeds a given value is marked with the classifying mark B, on the basis of that score and the relevant data component corresponding information (2c) described above, and data that was not marked with the classifying mark B is marked by a doctor with a classifying mark C.

With a data analysis device according to one aspect of the present invention, in order to apply, to data, a classifying mark indicating relevance to a predetermined symptom, input of a classifying mark is received from a doctor, the data is classified by classifying mark, a data component that commonly appears in the classified data is analyzed and selected, and the selected data component is searched for among the data. Using the results of the searching and the results of analyzing the data component, a score indicating relevance between the classifying mark and the data is calculated and the classifying mark is applied to data on the basis of the calculated score.

With a data analysis device according to one aspect of the present invention, a doctor registers data components for determining whether or not there is relevance to a predetermined symptom in a database. The data components registered in the database are searched for among the data, and sentences including the searched data components are extracted from the data. A score indicating a degree of relevance to the predetermined symptom is calculated depending on a characteristic volume extracted from the extracted sentences and, a degree of emphasis of the sentence is changed in accordance with the score.

With a data analysis device according to one aspect of the present invention, results of a judgement of relevance to a predetermined symptom, performed by a doctor, or a progression rate of a determination of relevance is recorded as performance information. Prediction information related to the results or the progression rates is generated, and the performance information and the prediction information are compared. An icon displaying the evaluation by a doctor of the judgement of relevance is generated on the basis of the comparison results.

With a data analysis device according to one aspect of the present invention, input from a doctor is received for result information indicating relevance between data and a predetermined symptom. From the characteristics of a data component that commonly appears in the data, an evaluation value of that data component is calculated for each of the result information. The data component is selected on the basis of the evaluation value, a score of the data is calculated from the selected data component and the evaluation value thereof, and a recall ratio is calculated on the basis of the score.

With a data analysis device according to one aspect of the present invention, data is displayed to a doctor, and identification information (a tag), applied by the doctor to review subject data on the basis of a judgement as to whether or not there is relevance to the predetermined symptom, is received. Characteristic volume of the tagged subject data and characteristic volume of the data are compared and, on the basis of the comparison results, a score of the data corresponding to a predetermined tag is updated. Furthermore, the display order of the data to be presented is controlled on the basis of the updated score.

With a data analysis device according to one aspect of the present invention, when source code is updated, the updated source code is recorded, an executable file is created from the recorded source code, the executable file is executed for the purpose of validation, the executed validation results are sent, and the transmission of the validation results are received by a server.

With a data analysis device according to one aspect of the present invention, data for a doctor to judge relevance to a predetermined symptom and classification buttons for allowing a doctor to select classification criteria for classifying the data are displayed. Information related to the classification button selected by the doctor is received as selection information and, the data is classified according to the results of analyzing the data on the basis of the selection information. Furthermore, the data is displayed on the basis of the results of the classification.

With a data analysis device according to one aspect of the present invention, supplementary information of voice and image data is individually confirmed, and the voice and image data is classified on the basis of the supplementary information. Components included in the supplementary information of the classified voice and image data is extracted. A degree of similarity is analyzed on the basis of the extracted components, and an integrated analysis is performed on the basis of the degree of similarity.

With the data analysis device according to one aspect of the present invention, a password-protected file that is protected with a password is extracted. Using a dictionary file in which candidate words intended as candidates for the password are recorded, the candidate words are input to the password-protected file. Then, results of a judgement performed by a doctor on the password-unprotected file as to the relevance with a predetermined symptom is received.

With a data analysis device according to one aspect of the present invention, data of a binary format search target file is divided into a plurality of blocks. The data of the blocks is searched for from a binary format search destination file, and the results of the search are output.

With a data analysis device according to one aspect of the present invention, subject digital information that serves as a research subject is selected, and a combination of a plurality of words having relevance to a specific matter is stored. The selected subject digital information is searched as to whether or not the stored combination of a plurality of words is included. If included, relevance of the subject digital information to the specific matter is determined on the basis of results of a morphological analysis, and the determination results are associated with the subject digital information.

With a data analysis device according to one aspect of the present invention, an image group or voice group is extracted from image information or voice information. Input from a doctor of a classifying mark is received in order to apply a classifying mark to the image group or voice group. The image group or voice group is divided by the classifying mark, and data components appearing in common in the divided image group or voice group are analyzed and selected. The selected data components are searched for among the image information or voice information. Using the results of the searching and the results of analyzing the data components, a score is calculated, on the basis of this calculated score, a classifying mark is applied to the image information or the voice information, and score calculation results and classifying results are displayed on a screen. The number of images and the number of voices for which reconfirmation is needed are calculated on the basis of a relationship between the recall ratio and the normalized position.

With a data analysis device according to one aspect of the present invention, (1a) a classifying mark A, (1b) a data component included in data marked with the classifying mark A, and (1c) data component corresponding information indicating a correspondence relationship between the classifying mark A and the data component are saved in a data component database. Furthermore, (2a) a classifying mark B, (2b) a relevant data component with a high frequency of appearance in the data marked with the classifying mark B, and (2c) relevant data component corresponding information indicating a correspondence relationship between the classifying mark B and the relevant data component are saved in a relevant data element database. Data including the data component (1b) described above is marked with the classifying mark A, on the basis of the data component corresponding information (1c) described above. Data including the relevant data component (2b) described above is extracted from the data that was not marked with the classifying mark A, and a score is calculated on the basis of an evaluation value/number of the relevant data component. Moreover, data with a score that exceeds a given value is marked with the classifying mark B, on the basis of that score and the relevant data component corresponding information (2c) described above. Furthermore, data that was not marked with the classifying mark B is marked with a classifying mark C by a doctor. The data marked with the classifying mark C is analyzed and, on the basis of the results of the analysis, data that was not marked with the classifying mark is marked with a classifying mark D.

With a data analysis device according to one aspect of the present invention, a score indicating relevance to a predetermined symptom is calculated for each piece of data. The data is extracted in a predetermined order on the basis of the calculated scores, and classifying marks, applied by a doctor to the extracted data on the basis of relevance to a predetermined symptom, are received. The extracted data is classified by classifying mark on the basis of the classifying marks, and data components appearing in common in the classified data are analyzed and selected. The selected data components are searched for among the data, and the score is recalculated for each piece of data using the search results and the analysis results.

With a data analysis device according to one aspect of the present invention, information relevant to a predetermined symptom is stored in a research basic database. Input of a category of the predetermined symptom is received, and a research category that serves as the subject of the research is determined on the basis of the received category. Required types of information are extracted from the research basic database.

With a data analysis device according to one aspect of the present invention, an action occurrence model, created on the basis of sending/receiving history of a message file on a network of an action subject that has performed a specific action, is stored. Profile information of the subject is created on the basis of the sending/receiving history of the message file on the network of the subject. A score indicating the compatibility between the profile information and the action occurrence model is calculated and, on the basis of the score, the possibility of a specific action occurring is determined.

With a data analysis device according to one aspect of the present invention, case research results including classifying work results by case pertaining to a predetermined symptom are collected; and a research model parameter for researching about the predetermined symptom is recorded. Upon input of research content of a new research case, the recorded research model parameter is searched for, and research model parameters relevant to the input information are extracted. Using the extracted research model parameter, the research model is output, and prior information for conducting research of the new research case is constituted from the output results of the research model.

With a data analysis device according to one aspect of the present invention, patient information related to a patient is acquired, and digital information is acquired that was updated at regular time intervals on the basis of the patient information. A plurality of files constituting the acquired digital information is organized in a predetermined save location on the basis of the recording destination information, file name, and metadata related to the acquired digital information. A visualized situation distribution is created from the situations of the organized plurality of files so that the situation of the patient that accessed the digital information can be understood.

With a data analysis device according to one aspect of the present invention, metadata associated with digital information is acquired. A weight parameter set is updated on the basis of a relationship between the metadata and first digital information related to a specific matter. Relevance between a morpheme and the digital information is updated using the weight parameter set.

With a data analysis device according to one aspect of the present invention, a classifying mark manually applied to subject data is received, and a relevance score of the subject data is calculated. The correctness of the classifying mark is determined on the basis of the relevance score, and the classifying mark that should be applied to the subject data is determined on the basis of the results of the determination of correctness.

With a data analysis device according to one aspect of the present invention, input of a category to which a predetermined symptom belongs is received, and research is performed on the basis of the received category. A report for reporting the results of the research is created, and information relevant to the predetermined symptom is stored in a research basic database. A research category that is the subject of the research is determined on the basis of the received category, and required types of information are extracted from the research basic database. The extracted types of information are presented to a doctor; input of data components to be used in applying a classifying mark corresponding to the presented type of information, is received from the doctor; and the classifying mark is automatically applied to the data.

With a data analysis device according to one aspect of the present invention, public information of the subject is acquired, the public information is analyzed, and extrinsic components of the subject are output. An action occurrence model based on action extrinsic components of an action subject that has performed a certain action is stored, and an action cause complying with the action occurrence model is extracted from the extrinsic components of the subject and stored. Inside information of the subject is acquired, the inside information is analyzed, and inside components of the subject are output. An analysis subject is automatically identified on the basis of the similarity between the inside components and the action cause.

With the data analysis device according to one aspect of the present invention, relevance information indicating relevance between digital information and a specific matter is acquired from a doctor. A relevance score determined in accordance with the relevance between the digital information and the specific matter is calculated for each piece of digital information. For each predetermined range of the relevance scores, a ratio of the number of pieces of relevance information applied to the digital information within the range to the total number of pieces of digital information that have a relevance score included in each range is calculated. A plurality of divisions associated with each of the ranges is displayed with the color phase, brightness, or saturation thereof changed on the basis of the ratio.

With the data analysis device according to one aspect of the present invention, a score indicating the strength of a link between data and a classifying mark is chronologically calculated, and chronological changes in the score are detected from the calculated scores. When determining the detected chronological changes in the score, a degree of relevance between a research case and extracted data is investigated and determined on the basis of the results of a determination of the period when the score that has exceeded a predetermined reference value has changed.

With the data analysis device according to one aspect of the present invention, weight information that has relevance to a specific matter and that is associated with a plurality of data components that include a co-occurrence expression is stored, a score is associated with digital information and, on the basis of the score, sample digital information that becomes a sample is extracted from the digital information. The extracted sample digital information is analyzed and, thereby, the weight information is updated.

With a data analysis device according to one aspect of the present invention, a category, which is an index into which each piece of data included in a plurality of data can be classified, is selected, and a score is calculated for each category.

With the data analysis device according to one aspect of the present invention, a predetermined action by a predetermined action subject, which is the cause of a predetermined symptom, is classified into a phase depending on the progression of the predetermined action, and the phase is identified on the basis of a score. A change of the identified phase is predicted on the basis of the temporal transition of the phase.

With a data analysis device according to one aspect of the present invention, a generation process model, in which a predetermined action that is a cause of a predetermined symptom occurs, is stored for each phase, which are classified depending on the progression of the predetermined action. Information relevant to the predetermined symptom is stored for each category and generation process model. Chronological information indicating the temporal order of the phases is stored and, on the basis of this information, image information or voice information is analyzed. An index indicating the possibility of the predetermined action occurring is calculated from the results of the analysis.

With a data analysis device according to one aspect of the present invention, a generation process model in which a predetermined action that is a cause of a predetermined symptom occurs is stored for each phase, which are classified depending on the progression of the predetermined action. Information relevant to the predetermined symptom is stored for each category and generation process model. Chronological information indicating the temporal order of the phases is stored, and, a relationship between a plurality of people associated with the predetermined symptom is stored. The data is analyzed on the basis of these pieces of information, and a current phase is identified.

With a data analysis device according to one aspect of the present invention, in cases where a verb that expresses an action is included in voice, an object that expresses the target of the action is identified, and metadata indicating the attributes of the voice that includes the verb and the object is associated with that verb and object. A relationship between the voice and the symptom is evaluated on the basis of the association, and the relationship of the plurality of people that is relevant to a symptom is displayed.

With a data analysis device according to one aspect of the present invention, communication data, which is sent and received between a plurality of terminals and which is associated with each of a plurality of people, is acquired, and the content of the acquired communication data is analyzed. Using the analysis results, a relationship between the content of the communication data and a predetermined symptom is evaluated. On the basis of the evaluation results, the relationship of a plurality of people relevant to the predetermined symptom is displayed.

With the data analysis device according to one aspect of the present invention, a score, which indicates the strength of a link between data included in a data group and a classifying mark indicating a degree of relevance between the data group and a predetermined symptom, is calculated. This score is reported to a doctor, depending on the calculated score. A research report is output depending on the research type of the predetermined symptom.

With a data analysis device according to one aspect of the present invention, a database in which confidential information associated with a degree of confidentiality is stored is referenced, and a degree of leakage indicating the risk of the confidential information leaking due to accessing outside the network is calculated. The degree of confidentiality or the degree of leakage is determined as to whether or not a standard at which the confidential information leaks is met. In cases where it is determined that the standard is met, the subject of the leakage is identified.

With a data analysis device according to one aspect of the present invention, a series A of behavior included in a certain period and a series B of behavior included in a most recent period are compared and, as a result, a difference between the series A and the series B is extracted. The extracted difference is determined as to whether or not a standard has been reached that suggests that the risk of confidential information leaking has increased. In cases where it is determined that the standard has been reached, an administrator is informed of the risk.

With a data analysis device according to one aspect of the present invention, a data component vector, which indicates whether or not a predetermined data component is included in a sentence included in data (for example, voice recorded during an examination), is generated for each sentence. Each data component vector is multiplied by a correlation matrix indicating the correlation between the predetermined data component and another data component and, as a result, correlation vectors for each sentence are obtained. A score is calculated on the basis of a value obtained by summing all of the correlation vectors.

With a data analysis device according to one aspect of the present invention, weight of data components, which are included in classified data that was classified by a doctor as to whether or not a relationship with a predetermined symptom exists, is learned. Data components included in the classified data are searched for from unclassified data that is not yet classified by a doctor as to whether or not a relationship with the predetermined symptom exists. Using the searched data components and the learned weight of the data components, scores, for which the strength of a link between the unclassified data and the classifying marks is evaluated, are calculated.

### REFERENCE SIGNS LIST

1 Data
1a Data
1b Data
5a Review results (results of judgement by doctor)
5d Score
5e Score
6 Relevance threshold (predetermined threshold)
11 Data acquiring unit
12 Judged data acquiring unit
13 Component evaluating unit
14 Score calculating unit
15 Condition determining unit (excess determining unit)
16 Relationship evaluating unit
17 Relationship imparting unit
18 Data informing unit
19 Threshold identifying unit
100 Data analysis device

1. A data analysis device capable of extracting health care data related to a predetermined symptom from a plurality of health care data acquired from structured health care data and/or unstructured health care data, and of providing a predictive diagnosis for disease, the device comprising:
a relationship evaluating unit that, when unjudged health care data is newly acquired for which an existence of a relationship with the predetermined symptom has not been judged, evaluates a relationship between the unjudged health care data and the predetermined symptom on the basis of judged health care data for which a doctor has judged whether or not a relationship with the predetermined symptom exists; and
a data informing unit that informs a user seeking a predictive diagnosis for disease of the unjudged health care data in accordance with a relationship evaluated by the relationship evaluating unit.

2. The data analysis device according to claim 1, further comprising:
a score calculating unit that calculates a score indicating a strength of a relationship between predetermined health care data and the predetermined symptom,
the relationship evaluating unit that evaluates whether or not a relationship between the unjudged health care data and the predetermined symptom exists using a score calculated by the score calculating unit as an index indicating a relationship between the unjudged health care data and the predetermined symptom; and
upon the relationship evaluating unit evaluating that a relationship exists between the unjudged health care data and the predetermined symptom, the data informing unit informing the user seeking a predictive diagnosis for disease of the unjudged health care data.

3. The data analysis device according to claim 2, further comprising:
a component evaluating unit that evaluates each data component included in the judged health care data, on the basis of a predetermined standard,
wherein the score calculating unit calculates the score using results evaluated by the component evaluating unit.

4. The data analysis device according to claim 3, further comprising:
a threshold identifying unit that identifies, among a plurality of scores calculated by the score calculating unit as an index indicating the relationship between the judged health care data and the predetermined symptom, using the results evaluated by the component evaluating unit, a score capable of exceeding a target value set for a precision ratio as a predetermined threshold.

5. The data analysis device according to any one of claims 2 to 4, further comprising:
a condition determining unit that determines a level of correlation of a moving average of a plurality of scores, each calculated for each of a plurality of judged health care data acquired along a time sequence, with a moving average of a plurality of scores, each calculated for each of a plurality of unjudged health care data acquired along a time sequence,
wherein the relationship evaluating unit evaluates the relationship between the unjudged health care data and the predetermined symptom, on the basis of results determined by the condition determining unit.

6. The data analysis device according to any one of claims 1 to 5, further comprising:
a judged data acquiring unit that acquires the judged health care data by acquiring, from the doctor via a predetermined input unit, results judged by the doctor as to whether or not a relationship between the predetermined health care data and the predetermined symptom exists.

7. The data analysis device according to any one of claims 1 to 6, further comprising:
a relationship imparting unit that imparts relationship information indicating that a relationship exists between the unjudged health care data and the predetermined symptom, on the basis of results evaluated by the relationship evaluating unit.

8. The data analysis device according to any one of claims 1 to 7, further comprising:
a data acquiring unit that acquires, as the health care data, structured health care data including at least one of gene analysis data and health diagnosis data, and/or unstructured health care data including at least one of medical interview data, lifestyle data, patient clinical data, and family medical history.

9. The data analysis device according to any one of claims 1 to 8, wherein:
the predetermined symptom is a poor health condition.

10. A control method for a data analysis device capable of extracting health care data related to a predetermined symptom from a plurality of health care data acquired from structured health care data and/or unstructured health care data, and providing a predictive diagnosis for disease, the method comprising the steps of:
when unjudged health care data is newly acquired for which an existence of a relationship with the predetermined symptom has not been judged, evaluating a relationship between the unjudged health care data and the predetermined symptom on the basis of judged health care data for which a doctor has judged whether or not a relationship with the predetermined symptom exists; and
informing a user seeking a predictive diagnosis for disease of the unjudged health care data in accordance with a relationship evaluated in the relationship evaluating step.

11. A control program for a data analysis device capable of extracting health care data related to a predetermined symptom from a plurality of health care data acquired from structured health care data and/or unstructured health care data, and providing a predictive diagnosis for disease; the program configured to cause the data analysis device to execute:
a relationship evaluating function for, when unjudged health care data is newly acquired for which a relationship with the predetermined symptom has not been judged, evaluating a relationship between the unjudged health care data and the predetermined symptom on the basis of judged health care data for which a doctor has judged whether or not a relationship with the predetermined symptom exists; and
a data informing function for informing a user seeking a predictive diagnosis for disease of the unjudged health care data in accordance with a relationship evaluated by the relationship evaluating function.
